(19) United States
(12) Patent Application Publication
(10) Pub. No.: US 2016/0086584 A1
(43) Pub. Date: Mar. 24, 2016

(54) POP-UP DISPLAY DEVICE

(71) Applicant: MITSUBISHI ELECTRIC CORPORATION, Tokyo (JP)

(72) Inventor: Yusuke YOKOSUKA, Tokyo (JP)

(73) Assignee: MITSUBISHI ELECTRIC CORPORATION, TOKYO (JP)

(21) Appl. No.: 14/890,220

(22) PCT Filed: May 31, 2013
(86) PCT No.: PCT/JP2013/003450

§ 371 Date: Nov. 10, 2015

(51) Int. Cl. G09G 5/377; G09G 5/14; G06F 3/0481

(52) U.S. Cl. CPC G09G 5/377; G06F 3/0481; G06F 3/04817; G09G 5/14; G09G 2340/12

(57) ABSTRACT

Herein included are: an image display unit that displays hierarchical display images of an application constituted by software having one or more functions; a display information preserving unit in which settings of images to be displayed on the image display unit are preserved; and a display controlling unit that, when the hierarchical display images of the application preserved in the display information preserving unit are displayed, controls a pop-up image that corresponds to said application but is other than the display images, to be displayed on the front side of the hierarchical display images of the application.

### TECHNICAL FIELD

The present invention relates to a pop-up display device that performs pop-up displaying at the time of displaying a display image of an application constituted by software having an arbitrary function.

### BACKGROUND ART

Heretofore, pop-up displaying has been largely used that displays, as a graphical user interface (GUI), a pop-up image, for example, a pop-up menu or the like, in an overwriting manner on the front side of an already-displayed display screen. Accordingly, there are proposed many techniques for efficiently performing pop-up displaying.

For example, in Patent Document 1, there is disclosed a pop-up display device having a function that can, when a new pop-up image is displayed during displaying a plurality of pop-up images, select whether to delete or to keep displaying in a fixed period, the other pop-up images. According to this technique, each pop-up image can be changed in size or position arbitrarily, and further, a word balloon for a pop-up object can be displayed. This makes it possible to display a target pop-up image in an easily-viewable manner for a user even when a plurality of pop-up images emerges.

Further, in Patent Document 2, there is disclosed a pop-up display device that, in order to make a correspondence relationship between a pop-up source and a pop-up image easily recognizable, displays the pop-up image without hiding the pop-up source and in such a state that a word balloon is drawn out from the pop-up image.

### CITATION LIST

### Patent Document

Patent Document 1: Japanese Patent Specification No. 4033618

Patent Document 2: Japanese Patent Application Laid-open No. H10-320166

### SUMMARY OF THE INVENTION

### Problems to be Solved by the Invention

Meanwhile, in the case, for example, where pop-up displaying is accomplished in a conventional programming environment in which part (widget) groups of a button, a list, etc. for building GUIs have been provided beforehand, and with respect, for example, to menu widgets, etc. among the present widgets, a sub-menu image to be displayed at the time of pressing down a button on the menu is displayed on the front side of an application's window image. Thus, the sub-menu image is displayed on the most front side. Further, at that time, other than the main window image, a window image such as an alerting dialog can be displayed. These images are displayed in front more than the main window image.

However, in the pop-up displaying under the conventional programming environment, since there is focused only on a front-rear relationship between windows, such a problem arises that the window images other than the main window image are placed and hidden under (behind) the sub-menu image of the main window image and this is unfavorable in respect of displaying.

In the case of a GUI application on a PC (Personal Computer), since it is basically activated only by a user's operation, such as, pressing down of a mouse, pressing down of a keyboard, etc. with respect to a window operation, there is no case falling in such a display state; however, in the case of a system such as a smartphone or car-navigation system in which a pop-up image is suddenly displayed, without due to a user's operation, in response to the time of incoming phone call or the like, the above-described display state may readily emerges.

However, since the menu widget is just a versatile component, it is difficult to control such that the sub-menu image is displayed under (behind) the window (dialog) image specific to each application. Further, as shown in Patent Document 1 and Patent Document 2, there are disclosures in many patents related to cases of displaying a plurality of pop-up parts; however, there is no disclosure about how to deal with the problem as described above.

This invention has been made to solve problems including the above problem, and an object thereof is to provide a pup-up display device that can easily control a display order of application pop-ups.

### Means for Solving the Problems

A pop-up display device according to the invention comprises: an image display that displays hierarchical display images of an application constituted by software having one or more functions; a display information preserver in which settings of images to be displayed on the image display are preserved; and a display controller that, when the hierarchical display images of the application preserved in the display information preserver are displayed, controls a pop-up image that corresponds to said application but is other than the display images, to be displayed on the front side of the hierarchical display images of the application.

### Effect of the Invention

According to this invention, it becomes possible to easily control a display order of the application pop-ups.

### BRIEF DESCRIPTION OF THE DRAWINGS

FIG. 1 is a block diagram showing an outline configuration of a pop-up display device according to Embodiment 1.

FIG. 2 is a functional block diagram of the pop-up display device according to Embodiment 1.

FIG. 3 is an illustration diagram showing an application configuration according to Embodiment 1.

FIG. 4 is an illustration diagram showing an internal configuration of a display stack 161.

FIG. 5 is an illustration diagram showing an internal configuration of a display stack 151.

FIG. 6 is a flowchart showing an operation flow of a display control unit 12.

FIG. 7 is an illustration diagram showing an example of pop-up displaying according to Embodiment 1.

FIG. 8 is an illustration diagram showing an example of conventional pop-up displaying.

FIG. 9 is an illustration diagram showing an application configuration according to Embodiment 2.

FIG. 10 is an illustration diagram showing an internal configuration of a display stack 171.

### MODES FOR CARRYING OUT THE INVENTION

Hereinafter, for illustrating this invention in more detail, embodiments for carrying out the invention will be described. It should be noted that the embodiments shown below are each an example of the invention, so that the invention is not limited to the embodiments shown below.

### Embodiment 1

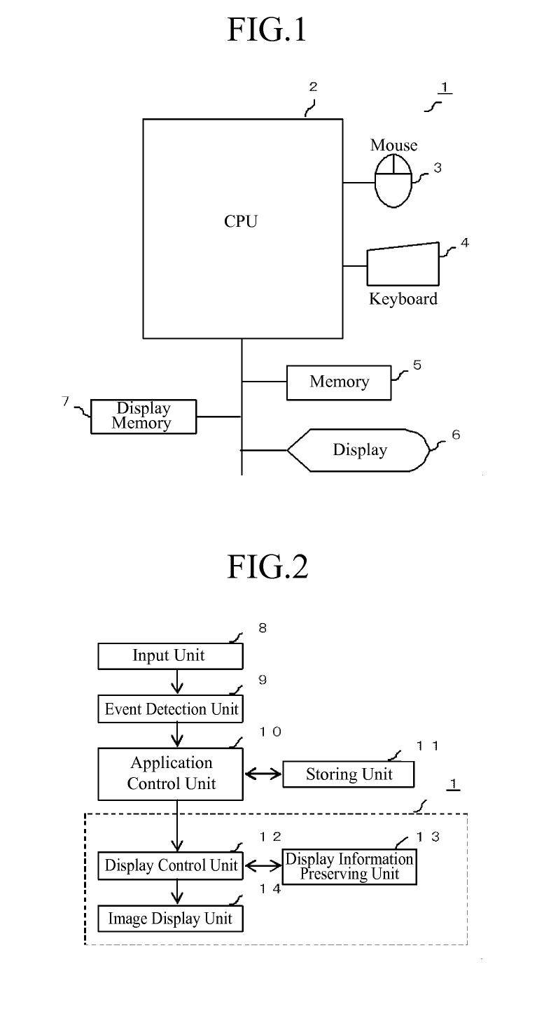

FIG. 1 is a block diagram showing an outline configuration of a pop-up display device according to Embodiment 1 of the invention. A pop-up display device 1 in FIG. 1 includes a CPU (Central Processing Unit) 2, a mouse 3, a keyboard 4, a memory 5, a display 6 and a display memory 7.

The CPU 2 detects an event on the basis of an input signal, etc. from the mouse 3 or the keyboard 4, to thereby perform operation of an application and controlling of a display image, according to the detected event. The mouse 3 and the keyboard 4 receive a user's operation and output signals according to the user's operation to the CPU 2. The memory 5 stores information to be used in the processing executed by the CPU 2. The display 6 displays a display image controlled by the CPU 2. The display memory 7 stores information of the display image to be displayed on the display 6.

FIG. 2 is a functional block diagram showing functional blocks of the pop-up display device according to Embodiment 1 of the invention.

An input unit 8 serves to receive a user's operation for an application and to output a signal according to said user's operation, and corresponds in this embodiment to the mouse 3 and the keyboard 4. An event detection unit 9 detects what event has occurred, on the basis of the signal outputted from the input unit 8, the state of the application, and the like. An application control unit 10 controls operation of the application on the basis of the event detected by the event detection unit 9. A storing unit 11 serves to store information of the application to be controlled by the application control unit 10, and corresponds in this embodiment to the memory 5. The display control unit 12 serves to perform controlling of a display image displayed on the display 6 under control of the application control unit 10, and controls, when hierarchical display images of the application are displayed, so that a pop-up image(s) corresponding to said application but other than display images is displayed on the front side of the hierarchical display images of the application. Note that in this embodiment, the event detection unit 9, the application control unit 10 and the display control unit 12 correspond to CPU 2. A display information preserving unit 13 serves to store the information of the display image to be displayed on the display 6, and corresponds in this embodiment to the display memory 7. An image display unit 14 displays the display image of the application. In this embodiment, it serves to display the hierarchical display images of the application, and corresponds to the display 6.

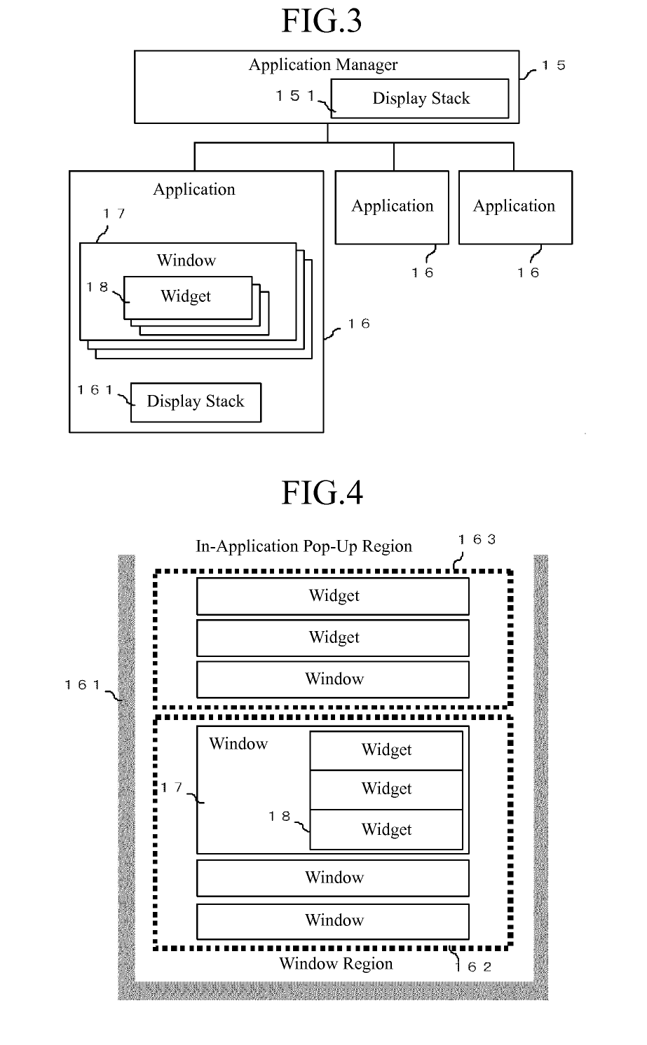

FIG. 3 is an illustration diagram showing an application configuration of the pop-up display device 1.

In FIG. 3, an application manager 15 preserves and manages one or more applications 16. Each application 16 is constituted by software having one or more functions, and, for example, has a function for an user to execute an arbitrary work (for example, mail transmission/reception, music playback, etc.). In FIG. 3, the application manager 15 preserves and manages three applications 16, which are applications having respective different functions.

The application 16 preserves display contents and operations per each application unit, each in a form of a window 17 as an internal functional unit. Thus, the application 16 has more than one window 17. Each window 17 is composed of a combination of more than one widget 18 such as a button, a list and the like.

Further, the application 16 and the application manager 15 have display stacks 161, 151 therein, respectively. These display stacks 161, 151 are preserved in the display information preserving unit 13.

The display stack 161 is used to manage an overlapping order in display of window images of the windows 17 (and widget images of the widgets 18 therein) under management in the application 16. For example, when there is a need to change the overlapping order of the window images on the basis of the event detected by the event detection unit 9, the display control unit 12 rearranges the order of the window images (and the widget images therein) preserved in the display stack 161 into an overlapping order matched to the event, and controls them to be displayed on the image display unit 14 in the order after the rearrangement. In this manner, when the display images and information about the overlapping order of that display images are stored as image-setup information in the display stack 161 and the display images are controlled based on the stored information, it becomes possible to rearrange the overlapping order of them displayed on the image display unit 14.

Likewise, the display stack 151 is used to manage an overlapping order in display of the applications 16.

Next, internal configurations of the display stacks will be described.

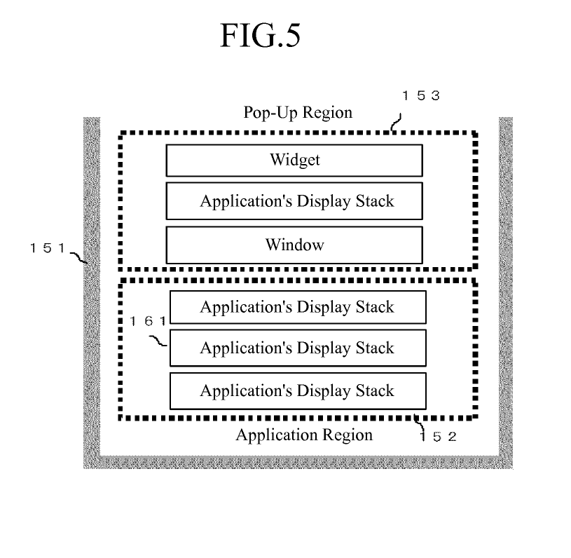

FIG. 4 is an illustration diagram showing the internal configuration of the display stack 161 of the application 16.

The display stack 161 has a window region 162 and an in-application pop-up region 163. The window 17 is composed, generally, of one or more widgets 18, and the display information of the window image of the window 17 is composed of display information of the widget images of the widgets 18. The thus-composed window image per each window unit is stored in the window region 162. Note that this window image per each window unit is comparable to a window display image corresponding to each hierarchy of the hierarchical display images of the application. In this embodiment, in the window region 162, there are stored three window images each per each window unit. Further, the window images of the respective windows are stored in an order from bottom to top in the window region 162 to be in conformity with the display-overlapping order from the rear side to the front side on the display screen. Namely, the stored order corresponds to information of the overlapping order of display images. In such a case where a plurality of window images are stored in the window region 162, when the respective window images are displayed on the image display unit in an overlapped manner in an order from the rear side to the front side, hierarchical display images in a single application are displayed.

In the in-application pop-up region 163 in the display stack 161, there are stored in-application pop-up images. The in-application pop-up image is an image corresponding for example to a component, such as a widget, a sub-widget or the like (what is meant here is a child element preserved in a widget, such as a sub-menu preserved in a menu part as a widget) that is wanted to be displayed like a sub-menu, on the front side of another window or another widget. In this embodiment, three images each corresponding to a window or a widget, are stored in the in-application pop-up region 163. Further, they are stored in an order from bottom to top in the in-application pop-up region 163 to be in conformity with the display-overlapping order from the rear side to the front side on the display screen. Namely, the stored order corresponds to information of the overlapping order of display images. In such a case where a plurality of images are stored in the in-application pop-up region 163, when the respective images are displayed on the image display unit in an overlapped manner in an order from the rear side to the front side, hierarchical display images in pop-up displaying in a single application are displayed.

Further, with respect to the window region 162 and the in-application pop-up region 163, the images of the in-application pop-up region 163 are being stored on the window images of the window region 162 to be in conformity with the display-overlapping order from the rear side to the front side on the display screen. Namely, the stored order of the respective regions corresponds to information of the overlapping order of display images. In such a case where the images of the in-application pop-up region 163 and the window images of the window region 162 are stored, when the respective images are displayed on the image display unit in an overlapped manner in an order from the rear side to the front side, the in-application pop-up images preserved in the in-application pop-up region 163 are pop-up displayed in front more than any window image of the window images preserved in the window region 162, so that hierarchical display images are displayed by the window images and the in-application pop-up images in a single application.

FIG. 5 is an illustration diagram showing the internal configuration of the display stack 151 of the application manager 15.

The display stack 151 has an application region 152 and a pop-up region 153. In the application's display stack 152, there is stored each piece of display-image information per each application unit and, for example, there is stored the display-image information, like the application's display stack shown in FIG. 4. In this embodiment, in the application region 152, there are stored images each per each display-stack unit of three applications. Further, the images each per each display-stack unit of the respective applications are stored in an order from bottom to top in the application region 152 to be in conformity with the display-overlapping order from the rear side to the front side on the display screen. Namely, the stored order corresponds to information of the overlapping order of display images. In such a case where the images each per each display-stack unit of a plurality of applications are stored in the application region 152, when the respective images are displayed on the image display unit in an overlapped manner in an order from the rear side to the front side, hierarchical display images by the plurality of applications are displayed.

In the pop-up region 153 in the display stack 151, there are stored pop-up images. The pop-up image is an image other than the set of hierarchical display images of each application stored in the application region 152, and is an image that is to be displayed in front more than the images stored in the application region 152. The pop-up image may be any display image corresponding to a component, such as, not only a widget but also a window, an application, etc.

For example, when, like a case of displaying an incoming phone call, a window has to be displayed—even if the other applications are being displayed—in the frontmost side of every application by the control of the application control unit 10 based on the event detected by the event detection unit 9, the window image of that window is stored in the pop-up region 153.

In this embodiment, in the pop-up region 153, there are stored three images each corresponding to a widget, a window or an application. Further, they are stored in an order from bottom to top in the pop-up region 153 to be in conformity with the display-overlapping order from the rear side to the front side on the display screen. Namely, the stored order corresponds to information of the overlapping order of display images. In such a case where a plurality of images are stored in the pop-up region 153, when the respective images are displayed on the image display unit in an overlapped manner in an order from the rear side to the front side, hierarchical display images in pop-up displaying are displayed.

Further, with respect to the application region 152 and the pop-up region 153, the pop-up images of the pop-up region 153 are being stored on the images of the application region 152 to be in conformity with the display-overlapping order from the rear side to the front side on the display screen. Namely, the stored order of the respective regions corresponds to information of the overlapping order of display images. In such a case where the pop-up images of the pop-up region 153 and the images of the application region 152 are stored, when the respective images are displayed on the image display unit in an overlapped manner in an order from the rear side to the front side, the pop-up images preserved in the pop-up region 153 are pop-up displayed in front more than any image among the images preserved in the application region 152, so that hierarchical display images are displayed by the application images and the pop-up images.

Note that the images stored in the display stack 151 and the display stack 161 are images created by the display control unit 12 according to instructions from the application control unit 10 or images prepared beforehand, which have been stored by the display control unit 12 according to instructions from the application unit 10.

Next, an operation of the display control unit 12 at the time of displaying display images will be described.

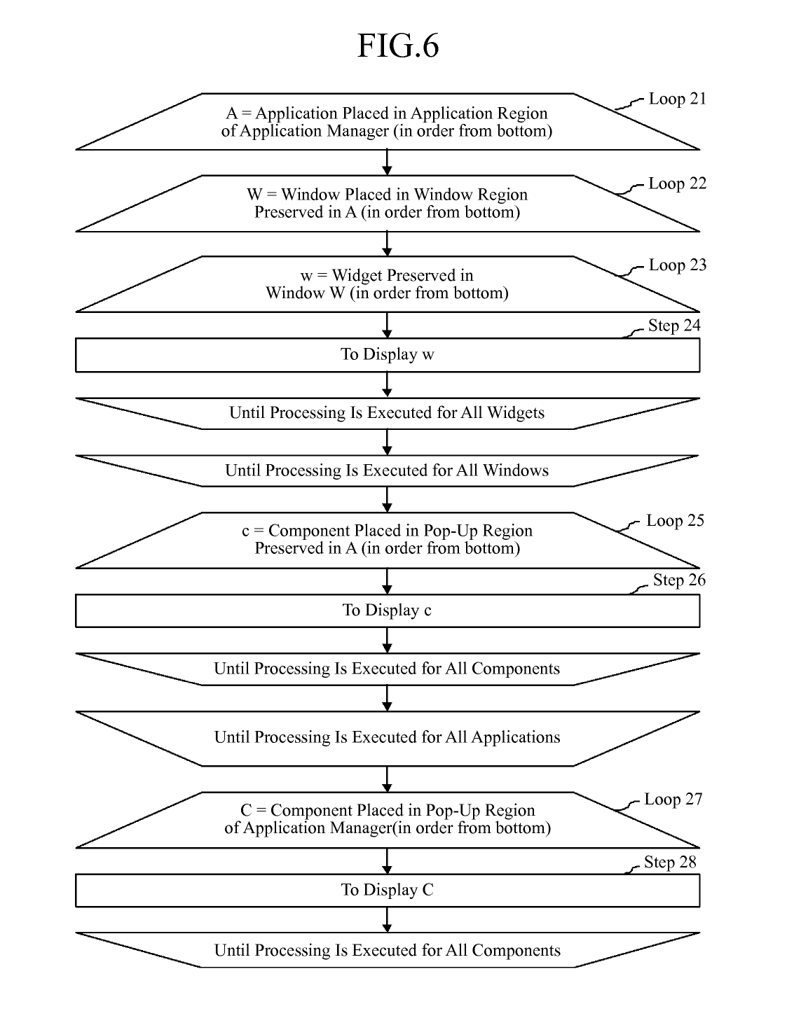

FIG. 6 is a flowchart showing the operation flow of the display control unit 12.

The display control unit 12, firstly in Loop 21, processes the respective applications 16 stored in the application region 152 in the display stack 151, in an order in the display stack from the bottom. Here, the currently-focused application is defined as A.

Then, in Loop 22, the windows 17 stored in the window region 162 in the display stack 161 preserved in A, are processed in an order in the display stack from the bottom. Here, the currently-focused window is defined as W.

Then, in Loop 23, the widgets preserved in W are processed in an order from the bottom. On this occasion, since the arrangement information of the widgets has already been put in the display stack 161, it suffices to perform processing in the order in that information. Here, the currently-focused widget is defined as w. In Step 24, this widget is displayed.

After completion of Loop 23 and Loop 22, in Loop 25, the components c (indicative of a widget and a window, herein) stored in the in-application pop-up region 163 preserved in A, are displayed in the order in the display stack from the bottom (Step 26).

After completion of Loop 25 and Loop 21, then in Loop 27, the components C stored in the pop-up region 153 of the application manager 15 are displayed in an order in the display stack from the bottom (Step 28).

When this Loop 27 is completed, a series of display processing by the application manager 15 is completed. Note that this operation is executed every time when a change in display content occurs, for example, when an event is detected by the event detection unit 9.

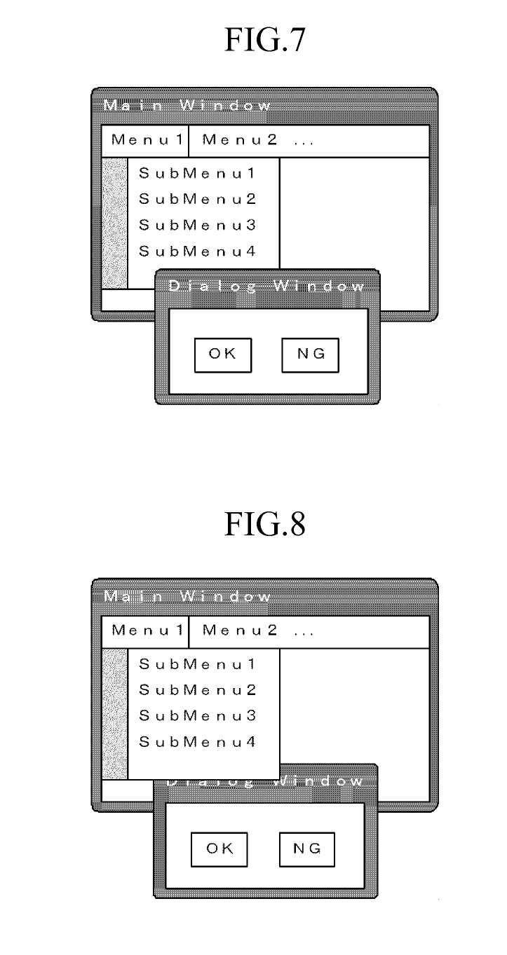

FIG. 7 is an illustration diagram showing an example of pop-up displaying according to this embodiment 1. FIG. 8 is an illustration diagram showing an example of conventional pop-up displaying.

As in FIG. 8, when hierarchical display images of an application are being displayed by a main window and a sub-menu, if an image of a dialog window for alerting is displayed, because there is focused only on a front-rear relationship between the main window and the dialog window, the image of the dialog window is placed and hidden under (behind) the sub-menu image in the main-window image.

In FIG. 7, when hierarchical display images of the application are being displayed by the main window and the sub-menu, if an image of the dialog window is displayed, the image of the dialog window is displayed on the frontmost side. This is because the window image of the main window is being stored in the window region 162 in FIG. 4, and the image of the sub-menu is being stored in the in-application pop-up region 163 in FIG. 4. This is further because the dialog window is being stored in the pop-up region 153 in FIG. 5.

As described above, according to this embodiment, it includes the display control unit that, when hierarchical display images of an application are displayed, controls the pop-up images corresponding to said application but other than display images, to be displayed on the front side of the hierarchical display images of the application, so that it becomes possible to easily control the display order of the application pop-ups even in such an environment where a group of widgets are provided as a framework, for example.

Further, according to this embodiment, the display information preserving unit is separately preserving in the display stack of the application manager, the pop-up images and the hierarchical display images of the application, respectively, in the pop-up region and the application region; and the display control unit controls to display the pop-up images preserved in the pop-up region, on the front side of the hierarchical display images of the application preserved in the application region, so that the pop-up images are displayed on the front side of the hierarchical display images in a single application. Thus, it becomes possible to easily control the display order of the application pop-ups.

Further, according to this embodiment, the display information preserving unit is separately preserving in the display stack of the application, the window display images corresponding to the respective hierarchies of the hierarchical display images of the application and the in-application pop-up images other than said window images, in the window region and the in-application pop-up region, respectively; and the display control unit controls to display the in-application pop-up images preserved in the in-application pop-up region, on the front side of the window display images preserved in the window region, so that the in-application pop-up images in a single application and the pop-up images to be displayed preferentially on the front side of any one of the applications, are displayed distinctively. Thus, it becomes possible to easily control the display order of the application pop-ups.

Further, according to this embodiment, it is configured: so that the pop-up region and the application region are provided in the display stack of the application manager, and the window region and the in-application pop-up region are provided in the display stack of the application; and so that it is able to freely and individually select which portion in the above regions, each component, such as a widget, a window, or an application is placed in. This allows, with respect to the display position control, a creator of the respective components to give a certain priority to each piece of pop-up information (a priority in terms of whether to be placed above an application, or above a window) through a simple operation only by specifying a display area, to thereby fulfill the specification as desired. Thus, it becomes possible to easily control the display order of the application pop-ups.

For example, as described in the example shown in FIG. 7, when a sub-menu is stored in the in-application pop-up region 163 in the application and a dialog window is stored in the pop-up region 153 in the application manager, it becomes possible to display the dialog window above the sub-menu. Meanwhile, when, from this dialog window, another application is to be displayed above the former application, according to a conventional method, the sub-menu having been pop-up displayed has to be removed at the time of displaying the other application. This is because the sub-menu is otherwise displayed above such a new application. Thus, if returning to the former application again, it is difficult to get such a state where the sub-menu is being displayed. However, according to the present configuration, when returning to the former application again from the other application, it becomes possible to display, while keeping the sub-menu open, another application above them, so that internal control operation can also be simplified.

Note that, in this embodiment, the description has been made about a case where, with respect to the information of the overlapping order of the display images, an upper-lower order of the images stored in the display stack and the overlapping order of the display images are made corresponding to each other; however, the upper-lower order of the images stored in the display stack may not be such a physical order, and may be a logically established order, of course.

Further, in this embodiment, the description has been made about a case where there is provided the input unit 8, and the event detection unit 9 detects what event has occurred, on the basis of the signal outputted from the input unit 8, the state of the application, and the like; however, in the case where the event detection unit 9 detects an occurrence of an event without being based on the signal outputted from the input unit 8, the configuration may be that in which the input unit 8 is removed.

### Embodiment 2

While the foregoing Embodiment 1 is that which preserves two pop-up regions of an in-application pop-up region and an inter-application pop-up region, in the following, an embodiment will be shown in which an area of the pop-up region is specified even in the window.

According to a pop-up display device of Embodiment 2, the block diagram showing its outline configuration and the functional block diagram showing its functional blocks, are the same as those of Embodiment 1, so that their description is omitted here.

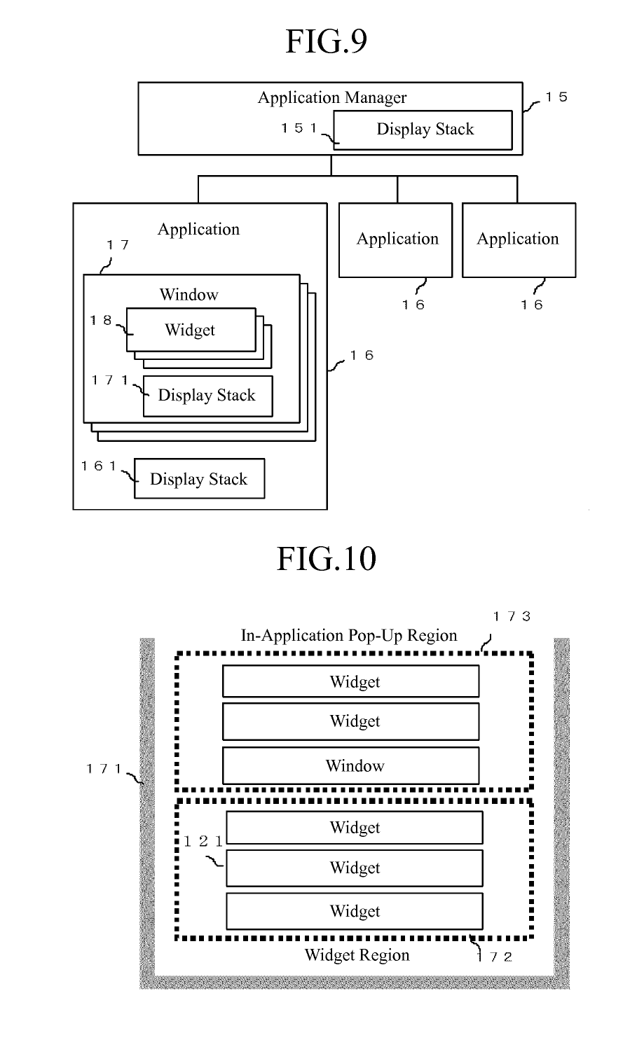

FIG. 9 is an illustration diagram showing an application configuration of the pop-up display device 1 of Embodiment 2. Since its basic configuration is the same as in FIG. 3, the same numerals are given to the same or equivalent parts in FIG. 3, so that their description is omitted here.

In FIG. 9, the windows 17 have their respective display stacks 171. These display stacks 171 are stored in the display information preserving unit 13. Each stack is similar in basic configuration to the display stack 161 in the application 16, and is used to manage an overlapping order in display of the widget images in the window. The display control unit 12 stores the display images and information about the overlapping order of that display images, as display setup information, in the display stack 171, and controls the display images on the basis of the stored information, so that the overlapping order of those displayed on the image display unit 14 can be rearranged.

FIG. 10 is an illustration diagram showing the internal configuration of the display stack 171.

The stack is basically similar to that shown in FIG. 4 or FIG. 5, and has internally a widget region 172 for normally arranging the widgets and an in-window pop-up region 173.

In this embodiment, the display control unit 12 performs processing of drawing the widget images of the respective widgets, in Loop 23 in FIG. 6 and further, in the order from the widget region 172 to the in-window pop-up region 173, as well as in the order from the bottom. With the provision of the in-window pop-up region 173 in this manner, it becomes possible to cause pop-up displaying in the window.

As described above, according to this embodiment, the widget display images for forming a window display image corresponding to each hierarchy of the hierarchical display images of the application, and the in-window pop-up images other than said widget display images, are separately stored in the widget region and the in-window pop-up region, respectively; and the display control unit controls to display the in-window pop-up images stored in the in-window pop-up region on the front side of the widget display images stored in the widget region. Namely, it is so configured that the regions each for storing a pop-up image are provided at in-window, inter-window (in application) and inter-application areas, respectively, so that in-window, intra-window (in-application) and intra-application pop-up displays are displayed, individually. Thus, it becomes possible to easily specify pop-up processing matched to a variety of functions, for example, to specify: as an in-window pop-up, a sub-menu; as an inter-window (in-application) pop-up, a window wanted to be displayed in the frontmost side in an application (for example, a file-open dialog, a color-selection dialog, or the like); and as an inter-application pop-up, a window of incoming phone call; or the like. Thus, it becomes possible to easily control the display order of the application pop-ups.

It should be noted that the foregoing embodiments will be applied, in a similar manner, to the case where a sub-window exists additionally in the window to provide a nested structure.

### INDUSTRIAL APPLICABILITY

As described above, the pop-up display device according to the invention is suited to be installed in an apparatus that performs pop-up displaying at the time of displaying hierarchical display images of the application constituted by software having an arbitrary function.

### DESCRIPTION OF REFERENCE NUMERALS and SIGNS

1: pop-up display device, 2: CPU, 3: mouse, 4: keyboard, 5: memory, 6: display, 7: display memory, 8: input unit, 9: event detection unit, 10: application control unit, 11: storing unit, 12: display control unit, 13: display information preserving unit, 14: image display unit, 15: application manager, 16: application, 17: window, 18: widget, 151: display stack, 161: display stack, 162: window region, 163: in-application pop-up region, 171: display stack, 172: widget region, 173: in-window pop-up region.

1. A pop-up display device, comprising:
an image display that displays hierarchical display images of an application constituted by software having one or more functions;
a display information preserver in which settings of images to be displayed on the image display are preserved; and
a display controller that, when the hierarchical display images of the application preserved in the display information preserver are displayed, controls a pop-up image that corresponds to said application but is other than the display images, to be displayed on the front side of the hierarchical display images of the application,
wherein the display information preserver separately preserves the pop-up image and the hierarchical display images of the plurality of applications in a pop-up region and an application region, respectively, and separately preserves window display images corresponding to respective hierarchies of the hierarchical display images of the application, and an in-application pop-up image other than the window display images, in a window region and an in-application pop-up region, respectively, and
wherein the display controller controls to display the pop-up image preserved in the pop-up region, on the front side of the hierarchical display images of the application preserved in the application region, and controls to display the in-application pop-up image preserved in the in-application pop-up region, on the front side of the window display images preserved in the window region.

2. (canceled)

3. (canceled)

4. The pop-up display device of claim 1, wherein:
the display information preserver separately preserves widget display images for forming window display images corresponding to respective hierarchies of the hierarchical display images of the application and an in-window pop-up image other than said widget display images, in a widget region and an in-window pop-up region, respectively; and
the display controller controls to display the in-window pop-up image preserved in the in-window pop-up region, on the front side of the widget display images preserved in the widget region.
